(19) United States
(12) Patent Application Publication
(10) Pub. No.: US 2025/0303770 A1
(43) Pub. Date: Oct. 2, 2025

(54) SYSTEM AND METHOD FOR PRESERVING INKJET OPERATIONAL STATUS DURING LONG PERIODS OF PRINTHEAD INACTIVITY

(71) Applicant: Xerox Corporation, Norwalk, CT (US)

(72) Inventors: Anthony S. Condello, Webster, NY (US); Jorge A. Alvarez, Webster, NY (US); Seemit Praharaj, Webster, NY (US); Jason M. LeFevre, Penfield, NY (US); Douglas K. Herrmann, Webster, NY (US)

(21) Appl. No.: 18/616,956

(22) Filed: Mar. 26, 2024

(51) Int. Cl. B41J 31/05; B41J 2/165; B41J 2/17; B41J 31/04

(52) U.S. Cl. CPC B41J 31/05; B41J 2/1721; B41J 31/04; B41J 2002/16558

(57) ABSTRACT

An inkjet printer includes a printhead maintenance station having a purge station for receiving ink purged from a printhead and an inkjet preservation station configured to contact a faceplate of the printhead with a solvent. The inkjet preservation station maintains the operational status of the inkjets in the printheads of the printer during long periods of printer inactivity.

### TECHNICAL FIELD

This disclosure relates generally to devices that produce ink images on media, and more particularly, to the preservation of inkjet operational status during long periods of printhead inactivity.

### BACKGROUND

Inkjet imaging devices, also known as inkjet printers, eject liquid ink from printheads to form images on an image receiving surface. The printheads include a plurality of inkjets that are arranged in an array. Each inkjet has a thermal or piezoelectric actuator that is coupled to a printhead controller. The printhead controller generates firing signals that correspond to digital data content that define the images. The actuators in the printheads respond to the firing signals by expanding into an ink chamber fluidly connected to a nozzle to eject ink drops from the nozzle onto the image receiving surface to form an ink image that corresponds to the digital image content used to generate the firing signals. The image receiving surface is usually a continuous web of media material or a series of media sheets.

Inkjet printers used for producing color images typically include multiple printhead modules. Each printhead module includes one or more printheads that typically eject a single color of ink. In a typical inkjet color printer, four printhead modules are positioned in a process direction with each printhead module ejecting a different color of ink. The four ink colors most frequently used are cyan, magenta, yellow, and black. The common nomenclature for such printers is CMYK color printers. Some CMYK color printers have two printhead modules that print each color of ink. The printhead modules that print the same color of ink are offset from each other by one-half of the distance between adjacent inkjets in the cross-process direction to double the number of pixels per inch to increase the density of a line of the color of ink ejected by the printheads in the two modules. As used in this document, the term “process direction” means the direction of movement of the image receiving surface as it passes the printheads in the printer and the term “cross-process direction” means a direction that is perpendicular to the process direction in the plane of the image receiving surface.

Inkjets, especially those in printheads that eject aqueous inks, need to fire regularly to help prevent the ink in the nozzles from drying. After a period of use, the printheads tend to form and accumulate bits of dried ink, paper dust, and other undesirable materials floating around in the printhead environment. These foreign debris objects may enter or accumulate around the orifices of the inkjets and degrade the fidelity and path of the drops ejected by the printhead. This degradation has an adverse impact on the quality of the ink images produced by the printer.

To maintain the operational status of the inkjets, the printhead modules are moved from positions opposite the path of the image receiving substrates to printhead maintenance stations where the printheads are purged. Purging a printhead means a pressurized gas or liquid is applied to the ink supply chambers within a printhead to force ink from the chamber into the nozzles where the ink is emitted from the nozzles onto the faceplate. One or more wipers are then moved across the faceplate to remove the purged ink from the faceplate into a waste ink receptacle.

A purge may be performed to begin daily print operations and may be done at the end of the day before the printer is made inactive. Also, during printing operations, image quality metrics are generated to evaluate the image quality of the ink images being produced by the printer. When the image quality drops below a predetermined threshold, the printer is taken off line so purge operations can be conducted in an effort to restore the printheads to operational status. While these purge cycles can restore one or more of the printheads in the printer during active printer operations, they do little to prevent the drying or hardening of contaminating particle accumulations during printer standby or overnight inactivity. Thus, inkjet printers would benefit from being able to maintain the operational status of the inkjets during long periods of printer inactivity following a purge cycle at the end of a printing day.

### SUMMARY

An inkjet printer includes a printhead maintenance station that is configured to maintain the operational status of the inkjets during long periods of printer inactivity. The inkjet printer includes at least one printhead module; and a printhead maintenance station, the printhead maintenance station including a purge station for receiving ink purged from a printhead; and an inkjet preservation station displaced from the purge station by a predetermined distance, the inkjet preservation station being configured to contact a faceplate of the printhead with a solvent.

A printhead maintenance station for a color inkjet printer is configured to maintain the operational status of the inkjets during long periods of printer inactivity. The printhead maintenance station includes a purge station for receiving ink purged from a printhead; and an inkjet preservation station displaced from the purge station by a predetermined distance, the inkjet preservation station being configured to contact a faceplate of the printhead with a solvent.

The printhead maintenance station includes a ribbon of inkjet preservation material that delivers solvent to the faceplate and nozzles of a printhead. The ribbon of inkjet preservation material includes a material configured to deliver solvent to a faceplate and nozzles of a printhead; and a solvent within the material that dissolves dried ink on the faceplate and nozzles of the printhead.

A method of operating a printhead maintenance station maintains the operational status of the inkjets during long periods of printer inactivity. The method includes moving at least one printhead module to a first position within a printhead maintenance station to purge ink from at least one printhead in the printhead module; and moving the at least one printhead in a cross-process direction from the first position to a second position within the printhead maintenance station to contact a faceplate of the at least one printhead with a solvent.

### BRIEF DESCRIPTION OF THE DRAWINGS

The foregoing aspects and other features of an inkjet printer, a printhead maintenance station, and an inkjet printer operational method that maintains the operational status of the inkjets in the printer during long periods of printer inactivity are explained in the following description, taken in connection with the accompanying drawings.

FIG. 1 is a schematic drawing of a color inkjet printer that maintains the operational status of inkjets in an inkjet printer during long periods of printer inactivity.

FIG. 2 depicts the print zone of the printer shown in FIG. 1 and the printhead maintenance stations positioned adjacent to the print zone.

FIG. 3A is a top view of an inkjet printer depicting the printhead maintenance station having two positions for printheads in a printhead module and FIG. 3B is a side view of the same printer.

FIG. 4 shows the components for performing a purge operation in the printhead maintenance station of FIG. 3A.

FIG. 5 depicts the inkjet preservation device within the printhead maintenance station of FIG. 3A.

FIG. 6 is a flow diagram for operating the printhead maintenance station of FIG. 3A.

### DETAILED DESCRIPTION

For a general understanding of the environment for the inkjet printer, printhead maintenance station, and the inkjet printer operational method disclosed herein as well as the details for the inkjet printer, the printhead maintenance station and the printhead maintenance station operational method, reference is made to the drawings. In the drawings, like reference numerals have been used throughout to designate like elements. As used herein, the word “printer” encompasses any apparatus that ejects ink drops onto different types of media to form ink images.

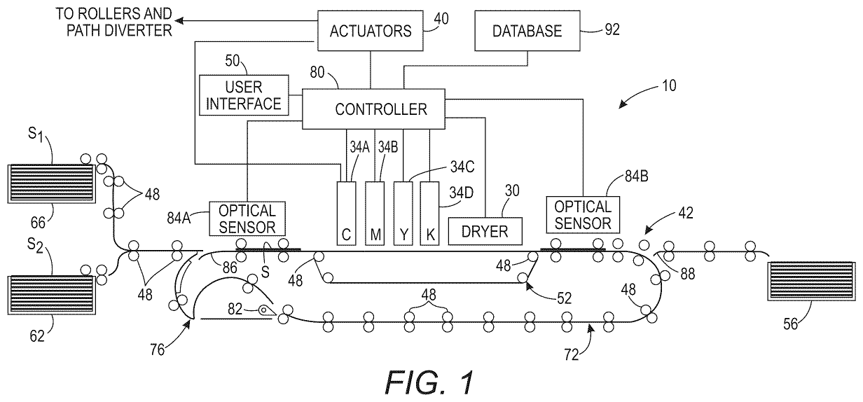

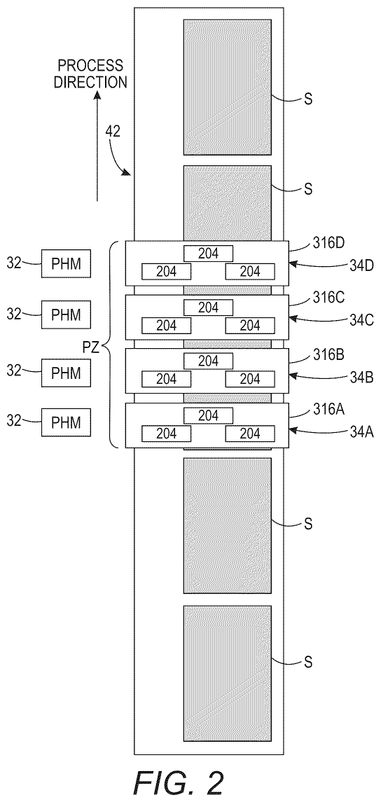

FIG. 1 depicts a high-speed color inkjet printer 10 that maintains the operational status of inkjets during long periods of printer inactivity. As used in this document, the term “long period of printer inactivity” means at least two hours of no printing being performed by a printer. As illustrated, the printer 10 is a printer that directly forms an ink image on a surface of a media sheet stripped from one of the supplies of media sheets S₁ or S₂ and the sheets S are moved through the printer 10 by the controller 80 operating one or more of the actuators 40 that are operatively connected to rollers or to at least one driving roller of conveyor 52 that comprise a portion of the media transport 42 that passes through the print zone PZ (shown in FIG. 2) of the printer. In one embodiment, each printhead module has only one printhead that has a width that corresponds to a width of the widest media in the cross-process direction that can be printed by the printer. In other embodiments, the printhead modules have a plurality of printheads with each printhead having a width that is less than a width of the widest media in the cross-process direction that the printer can print. In these modules, the printheads are arranged in an array of staggered printheads or a linear array of printheads that abut one another in the cross-process direction to enable media wider than a single printhead to be printed. Additionally, the printheads within a module or between printheads in different modules can also be interlaced so the density of the drops ejected by the printheads in the cross-process direction can be greater than the smallest spacing between the inkjets in a printhead in the cross-process direction. Although printer 10 is depicted with only two supplies of media sheets, the printer can be configured with three or more sheet supplies, each containing a different type or size of media.

The print zone PZ in the printer 10 of FIG. 1 is shown in FIG. 2. The print zone PZ has a length in the process direction commensurate with the distance from the first inkjets that a sheet passes in the process direction to the last inkjets that a sheet passes in the process direction and it has a width that is the maximum distance between the most outboard inkjets on opposite sides of the print zone that are directly across from one another in the cross-process direction. Each printhead module 34A, 34B, 34C, and 34D shown in FIG. 2 has three printheads 204 mounted to one of the printhead carrier plates 316A, 316B, 316C, and 316D, respectively. Adjacent to the print zone PZ are four printhead maintenance stations (PHM) 32. When the printer is going to be inactive for at least two hours of time, printing operations are halted and the printhead modules are moved from the print zone PZ to one of two positions within the adjacent printhead maintenance stations 32. The printhead maintenance station is operated as described in more detail below to position the printheads opposite a medium that contains a rejuvenating fluid. As used in this document, the term “print zone” means an area of a media transport opposite the printheads of an inkjet printer.

With further reference to FIG. 1, the printed image exits the print zone of printer 10 and passes under an image dryer 30 after the ink image is printed on a sheet S. As used in this document, the term “print zone” means an area of a media transport opposite the printheads of an inkjet printer. The image dryer 30 can include an infrared heater, a heated air blower, air returns, or combinations of these components to heat the ink image and at least partially fix an ink image to the sheet S. An infrared heater applies infrared heat to the printed image on the surface of the sheet S to evaporate water or solvent in the ink. The heated air blower directs heated air using a fan or other pressurized source of air over the ink to supplement the evaporation of the water or solvent from the ink. The air is then collected and evacuated by air returns to reduce the interference of the dryer air flow with other components in the printer.

Controller 80 operates at least one of the actuators 40 to rotate a pivoting member at position 88 to either direct a sheet to receptacle 56 or to return path 72. A sheet S is moved by the rotation of rollers along the return path 72 in a direction opposite to the direction of movement in the process direction past the printheads. Pivoting member 82 is operated by the controller 80 to either direct the sheet along a curved portion of the return path 72 into inverter 76 so the sheet is turned over for duplex printing or along the straight portion of the return path 72. When the sheet follows the straight portion, the inverter 76 is bypassed and the side of the sheet previously printed can be printed again. The controller operates one of the actuators 40 to move the pivoting member 82 clockwise to direct a sheet into the inverter 76 and counterclockwise to bypass the inverter. Regardless of whether the substrate is inverted or not, it merges into the job stream being carried by the media transport 42 when controller 80 operates another actuator 40 to rotate pivoting member 86 to provide ingress of a sheet S from return path 72 to the job stream entering the print zone.

As further shown in FIG. 1, the printed media sheets S not diverted to the duplex path 72 are carried by the media transport to the sheet receptacle 56 in which they are be collected. Before the printed sheets reach the receptacle 56, they pass by an optical sensor 84B. The optical sensor 84B generates image data of the printed sheets and this image data is analyzed by the controller 80 to detect streakiness in the printed images on the media sheets of a print job. Additionally, sheets that are printed with test pattern images are printed at intervals during the print job. Image data of these test pattern images generated by optical sensor 84B are analyzed by the controller 80 to determine which inkjets, if any, that were operated to eject ink into the test pattern did in fact do so, and if an inkjet did eject an ink drop whether the drop landed at its intended position with an appropriate mass. Any inkjet not ejecting an ink drop it was supposed to eject or ejecting a drop not having the correct mass or landing at an errant position is called an inoperative inkjet in this document. The controller can store data identifying the inoperative inkjets in database 92 operatively connected to the controller 80. These sheets printed with the test patterns are sometimes called run-time missing inkjet (RTMJ) sheets and these sheets are discarded from the output of the print job. A user can operate the user interface 50 to obtain reports displayed on the interface that identify the number of inoperative inkjets and the printheads in which the inoperative inkjets are located. For sheets that are not inverted and merged into the job stream by the operation of pivoting member 86, optical sensor 84A generates image data of the printed side and the controller 80 uses that image data to register the sheets and to operate the ejectors in the printhead to further print images on the previously printed sheet sides. The optical sensors 84A and 84B can be a digital camera, an array of LEDs and photodetectors, or other devices configured to generate image data of a passing surface. While FIG. 1 shows the printed sheets as being collected in the sheet receptacle 56, they can be directed to other processing stations (not shown) that perform tasks such as folding, collating, binding, and stapling of the media sheets.

Operation and control of the various subsystems, components and functions of the machine or printer 10 are performed with the aid of a controller or electronic subsystem (ESS) 80. The ESS or controller 80 is operatively connected to the components of the printhead modules 34A-34D (and thus the printheads), the actuators 40, and the dryer 30. The ESS or controller 80, for example, is a self-contained computer having a central processor unit (CPU) with electronic data storage, and a display or user interface (UI) 50. The ESS or controller 80, for example, includes a sensor input and control circuit as well as a pixel placement and control circuit. In addition, the CPU reads, captures, prepares, and manages the image data flow between image input sources, such as a scanning system or an online or a work station connection (not shown), and the printhead modules 34A-34D. As such, the ESS or controller 80 is the main multi-tasking processor for operating and controlling all of the other machine subsystems and functions, including the printing process.

The controller 80 can be implemented with general or specialized programmable processors that execute programmed instructions. The instructions and data required to perform the programmed functions can be stored in non-transitory computer readable medium associated with the processors or controllers. The processors, their memories, and interface circuitry configure the controllers to perform the operations described below. These components can be provided on a printed circuit card or provided as a circuit in an application specific integrated circuit (ASIC). Each of the circuits can be implemented with a separate processor or multiple circuits can be implemented on the same processor. Alternatively, the circuits can be implemented with discrete components or circuits provided in very large scale integrated (VLSI) circuits. Also, the circuits described herein can be implemented with a combination of processors, ASICs, discrete components, or VLSI circuits.

In operation, image content data for an image to be produced are sent to the controller 80 from either a scanning system or an online or work station connection for processing and generation of the printhead control signals output to the printhead modules 34A-34D. Along with the image content data, the controller receives print job parameters that identify the media weight, media dimensions, print speed, media type, ink area coverage to be produced on each side of each sheet, location of the image to be produced on each side of each sheet, media color, media fiber orientation for fibrous media, print zone temperature and humidity, media moisture content, and media manufacturer. As used in this document, the term “print job parameters” means non-image content data for a print job and the term “image content data” means digital data that identifies an ink image to be printed on a media sheet.

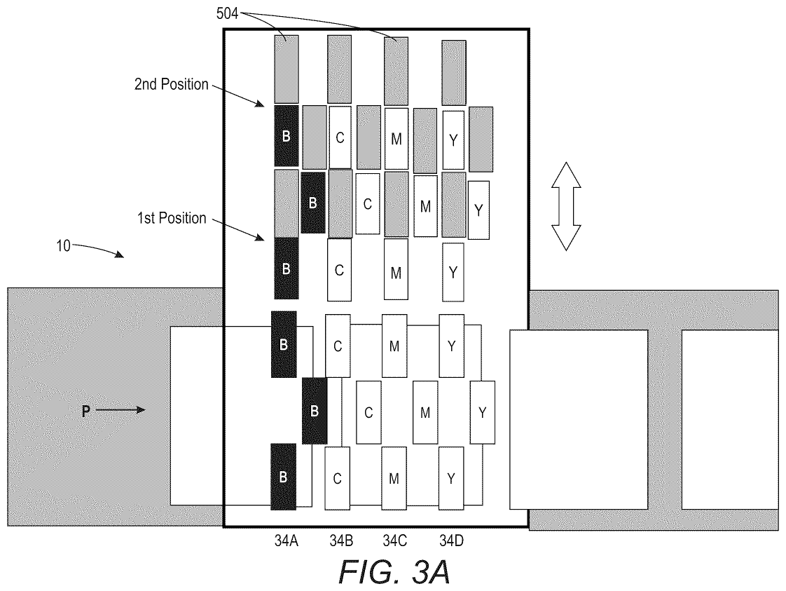

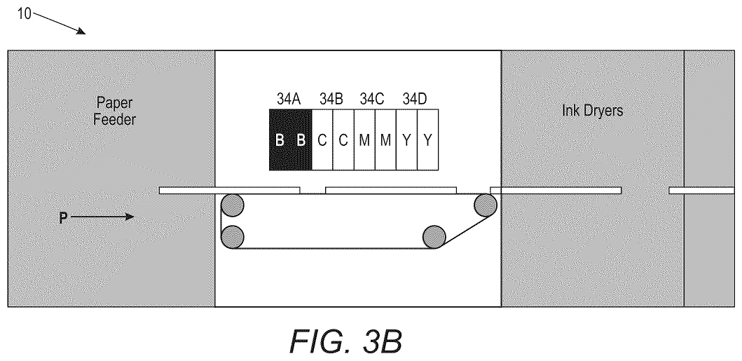

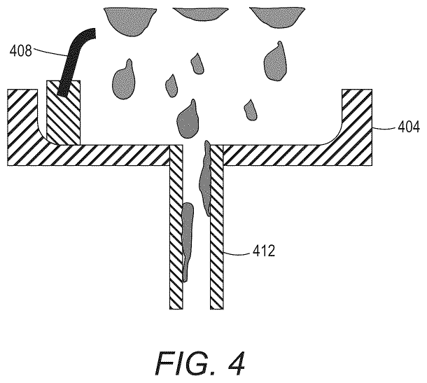

FIG. 3A is a view from above the print zone of an inkjet printer similar to the printer 10 of FIG. 1. The only difference is the order of the printhead modules. When the printer is being used to print ink images on media sheets, the sheets move through the printer in a process direction P. The printhead modules 34A to 34D are operatively connected to actuators 40 to translate the printhead modules from a position over the print zone to the printhead maintenance stations 304 that are adjacent to the print zone. When the controller 80 operates the actuators 40 operatively connected to the printhead modules, the printhead modules are translated in the cross-process direction to two positions within the printhead maintenance stations 304. In the first position adjacent to the print zone, the printheads of the modules are positioned over a purge station having a receptacle 404 so the printheads can be purged in a known manner and the faceplates be wiped with a wiper 408 to remove the purged drops from the faceplate and dropped into the receptacle 404 as shown in FIG. 4.

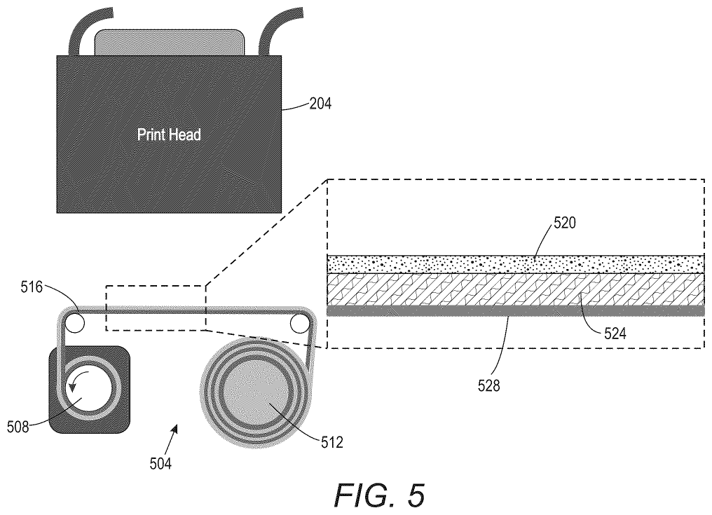

After the printheads have been purged and wiped so the purged ink is removed from the receptacle 404 through the drain 412 of the basin, the printhead modules are moved to a second position in the printhead maintenance station 304 that is opposite an inkjet preservation device 504 (FIG. 3A). The inkjet preservation devices 504 are displaced from the purge stations by a predetermined distance. As shown in FIG. 5, each inkjet preservation device 504 includes a supply roller 512, a take-up roller 508, and a continuous ribbon of inkjet preservation material 516. The take-up roller 508 is operatively connected to an actuator 40 so the controller 80 can operate the actuator to move a portion of the inkjet preservation material from being opposite a printhead 204 to the take-up roller 508. As shown in the expanded view of the inkjet preservation material 516 in FIG. 5, the material has three layers. The base of the ribbon material 528 is made of a thin and mostly inelastic material, such as polypropylene, to ensure dimensional stability for the ribbon and support the other layers. The thickness of the base layer is in a range of 30-100 μm ±5 μm and the width corresponds to a width of a printhead being engaged ±15 μm on each side of the printhead in the cross-process direction. The intermediate layer 524 is a thin porous material, such as a polymer foam, that absorbs and holds an appropriate amount of solvent material in proximity to the faceplate of the printhead 204. The thickness of layer 524 is in a range of 100-1000 μm±10 μm and the width corresponds to a width of a printhead being engaged ±10 μm on each side of the printhead in the cross-process direction. The layer of the ribbon 528 that contacts the faceplate of the printhead 204 is thin and made of a permeable material, such as a PTFE membrane, that enables an amount of solvent to permeate the ambient environment and moisten the faceplate without deteriorating from contacting the printhead, which is maintained at a temperature of approximately 370. The thickness of the membrane is in a range of 50-150 μm ±5 μm and the width of layer 528 corresponds to a width of a printhead being engaged ±5 μm on each side of the printhead in the cross-process direction. Such a membrane is available from SunGod Tech of Songjiang, Shanghai, PRC. As used in this document, the term “ribbon of inkjet preservation material” means a elongated member configured to deliver a solvent capable of dissolving dried ink on the faceplate of a printhead and within nozzles of the printhead.

The ribbon 528 is comprised of multi-functional layers and the ribbon is indexed by rotation of the take-up reel to ensure the capacity of the ribbon to maintain the operational status of the printhead inkjets. As the portion of the ribbon positioned opposite the printhead becomes contaminated with ink and other environmental debris, a fresh portion of the ribbon is provided from the supply reel. The periodicity of the ribbon refreshment can be on a time of usage basis or on a number of times used basis. Depending on the ribbon thickness, the ribbon may or may not be indexed every time the printheads are translated to the inkjet preservation device. Forward and reverse indexing of the ribbon may be used to maximize life of ribbon. The printhead may be disengaged or engaged with the ribbon during movement of the ribbon.

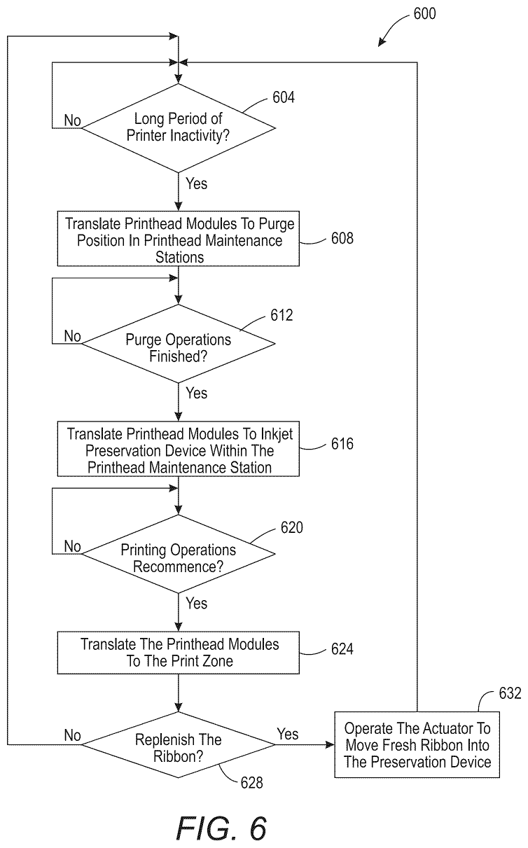

A process 600 for operating the inkjet printer of FIG. 1 to maintain the operational status of inkjets in the inkjet printer during long periods of printer inactivity is shown in FIG. 6. In the description of the process, statements that the process is performing some task or function refers to a controller or general purpose processor executing programmed instructions stored in non-transitory computer readable medium operatively connected to the controller or processor to manipulate data or to operate one or more components in the printer to perform the task or function. The controller 80 noted above can be such a controller or processor. Alternatively, the controller can be implemented with more than one processor and associated circuitry and components, each of which is configured to perform one or more tasks or functions described herein. Additionally, the steps of the method may be performed in any feasible chronological order, regardless of the order shown in the figures or the order in which the processing is described.

The process 600 of FIG. 6 begins by detecting the commencement of a long period of printer inactivity (block 604). The process operates actuators to translate the printhead modules in the cross-process direction to a first position in a printhead maintenance station where the printheads are purged (block 608). Once the purge operation is finished (block 612), the printhead module is translated to a second position in the printhead maintenance station where the printheads are positioned opposite an inkjet preservation device (block 616). The printheads remain in this position until printing operations are to recommence (block 620) and the printhead modules are translated back to the first position in the printhead maintenance station for a purge and wipe of the printheads before being returned to the print zone for printing operations (block 624). If the ribbon containing the solvent needs replenishing (block 628), an actuator is operated to advance the ribbon (block 632).

It will be appreciated that variants of the above-disclosed and other features, and functions, or alternatives thereof, may be desirably combined into many other different systems or applications. Various presently unforeseen or unanticipated alternatives, modifications, variations, or improvements therein may be subsequently made by those skilled in the art, which are also intended to be encompassed by the following claims.

What is claimed is:

1. A printhead maintenance station comprising:
a purge station for receiving ink purged from a printhead; and
an inkjet preservation station displaced from the purge station by a predetermined distance, the inkjet preservation station being configured to contact a faceplate of the printhead with a solvent.

2. The printhead maintenance station of claim 1, the inkjet preservation station further comprising:
a material configured to contact the faceplate of the printhead with the solvent.

3. The printhead maintenance station of claim 2, the material further comprising:
three layers of dissimilar materials.

4. The printhead maintenance station of claim 1 wherein the three layers comprise:
are an inelastic layer,
a porous layer; and
a layer that enables a solvent provided from the porous layer to be released against the faceplate of the printhead.

5. The printhead maintenance station of claim 4 wherein the inelastic layer is comprised essentially of polypropylene.

6. The printhead maintenance station of claim 4 wherein the porous layer is comprised essentially of polymer foam.

7. The printhead maintenance station of claim 4 wherein the layer that releases the solvent is comprised essentially of PTFE membrane material.

8. The printhead maintenance station of claim 2, the material being configured as a ribbon and the ribbon is operatively connected to a first reel and a second reel, the first reel being operatively connected to an actuator to move the ribbon from the second reel to the first reel.

9. The printhead maintenance station of claim 8, the actuator being operated to move the ribbon on a time of usage basis.

10. The printhead maintenance station of claim 8, the actuator being operated to move the ribbon on a number of times used basis.

11. An inkjet printer comprising:
at least one printhead module; and
a printhead maintenance station, the printhead maintenance station including:
a purge station for receiving ink purged from a printhead; and
an inkjet preservation station an inkjet preservation station displaced from the purge station by a predetermined distance, the inkjet preservation station being configured to contact a faceplate of the printhead with a solvent.

12. The inkjet printer of claim 11, the inkjet preservation station further comprising:
a material configured to contact the faceplate of the printhead with the solvent.

13. The inkjet printer of claim 2, the material further comprising:
three layers of dissimilar materials.

14. The inkjet printer of claim 11 wherein the three layers comprise:
are an inelastic layer,
a porous layer; and
a layer that enables a solvent provided from the porous layer to be released against the faceplate of the printhead.

15. The inkjet printer of claim 14 wherein the inelastic layer is comprised essentially of polypropylene.

16. The inkjet printer of claim 14 wherein the porous layer is comprised essentially of polymer foam.

17. The inkjet printer of claim 14 wherein the layer that releases the solvent is comprised essentially of PTFE membrane material.

18. The inkjet printer of claim 12, the material being configured as a ribbon and the ribbon is operatively connected to a first reel and a second reel, the first reel being operatively connected to an actuator to move the ribbon from the second reel to the first reel.

19. The inkjet printer of claim 18, the actuator being operated to move the ribbon on a time of usage basis.

20. The inkjet printer of claim 18, the actuator being operated to move the ribbon on a number of times used basis.

21. A method of operating an inkjet printer comprising:
moving at least one printhead module to a first position within a printhead maintenance station to purge ink from at least one printhead in the printhead module; and
moving the at least one printhead in a cross-process direction from the first position to a second position within the printhead maintenance station to contact a faceplate of the at least one printhead with a solvent.

22. The method of claim 21, the inkjet preservation station further comprising:
contacting the faceplate of the printhead with a material containing the solvent.

23. The method of claim 22, the material further comprising:
three layers of dissimilar materials.

24. The method of claim 21 further comprising:
operating an actuator to move the material from a second reel to a first reel.

25. The method of claim 24 further comprising:
operating the actuator to move the material on a time of usage basis.

26. The method of claim 25 further comprising:
operating the actuator to move the ribbon on a number of times used basis.

27. A ribbon of inkjet preservation material comprising:
a material configured to deliver solvent to a faceplate and nozzles of a printhead; and
a solvent within the material that dissolves dried ink on the faceplate and nozzles of the printhead.

28. The ribbon of claim 27 further comprising:
a first layer configured to ensure dimensional stability for the ribbon and support other layers positioned on the first layer;
a second layer configured to hold the solvent; and
a third layer configured to receive solvent from the second layer and deliver the solvent to the faceplate and nozzles.

29. The ribbon of claim 28 wherein the first layer is made of a thin and inelastic material.

30. The ribbon of claim 29 wherein the thin and inelastic material is polypropylene.

31. The ribbon of claim 28 wherein the second layer is a thin porous material.

32. The ribbon of claim 31 wherein the thin porous material is a polymer foam.

33. The ribbon of claim 32 wherein the third layer is a thin, permeable material.

34. The ribbon of claim 33 wherein the thin permeable material is a PTFE membrane.
